(19) United States
(12) Patent Application Publication
(10) Pub. No.: US 2003/0052140 A1
(43) Pub. Date: Mar. 20, 2003

(54) Aerosol spray tube holder

(76) Inventor: John P. Mouyos, Valley Center, CA (US)

Correspondence Address: NYDEGGER & ASSOCIATES, 348 OLIVE STREET, SAN DIEGO, CA, 92103, US

(21) Appl. No.: 09/740,139

(22) Filed: Jul. 19, 2001

(51) Int. Cl. B67D 5/06; B67D 3/00

(52) U.S. Cl. 222/538

(57) ABSTRACT

In the dispensing of a directional spray tube, a plastic holder is necessary to prevent loss of the spray tube. This invention is designed to attach the spray tube used with a typical aerosol can to a convenient easy-to-use holder directly affixed to the can. This device easily attaches to the can surface using the provided double sided tape, once there, it firmly holds the directional spray tube until required for use. When the spray tube is needed it is easily removed from spray tube holder by grasping the spray tube and snapping it out of the tube holder.

### CROSS REFERENCE TO RELATED APPLICATIONS

| | | |
|---|---|---|
| Patent Number | 5,143,263 | Sep. 1, 1992 |
| Patent Number | 5,772,084 | Jun. 30, 1998 |
| Patent Number | 5,601,216 | Feb. 11, 1997 |
| Patent Number | 4,941,594 | Jul. 17, 1990 |
| Patent Number | 4,823,445 | Apr. 25, 1989 |
| Patent Number | 4,819,838 | Apr. 11, 1989 |
| Patent Number | 3,186,645 | Jun. 1, 1965 |
| Patent Number | 2,963,167 | Dec. 6, 1960 |
| Patent Number | 2,618,088 | Nov. 18, 1952 |

Research and development on this idea/invention was paid for entirely by the inventor, John Mouyos. No federal sponsorship was requested or granted throughout research and development.

### BACKGROUND

The need was apparent to the inventor for a simple inexpensive way to keep the aerosol spray tube, normally provided by the aerosol product supplier, with the aerosol can. Most aerosol product suppliers merely affix this tube with a piece of tape, that once removed from the tube is seldom returned to the initial storage place. The aerosol spray tube holder was the inventor's solution to this problem. To provide a simple reusable inexpensive way to keep the tube with the can.

### SUMMARY OF THE INVENTION

A search of existing patents and patent applications revealed that this problem had occurred to others and there are several inventions that attempt to deal with the problem. However most are complex and inconvenient to use. Some even require the can to be modified to accept the holder. The “Aerosol Spray Tube Holder” can be affixed to any existing standard spray can by pulling off the protective plastic film from the adhesive and pressing the holder to the side of the can. The spray tube can then be snapped into the retainer arms until needed again. When spray can is empty the can and spray tube holder can be recycled appropriately.

### DESCRIPTION OF DRAWINGS

FIG. 1 Top, side and end views of “Aerosol Spray Tube Holder”

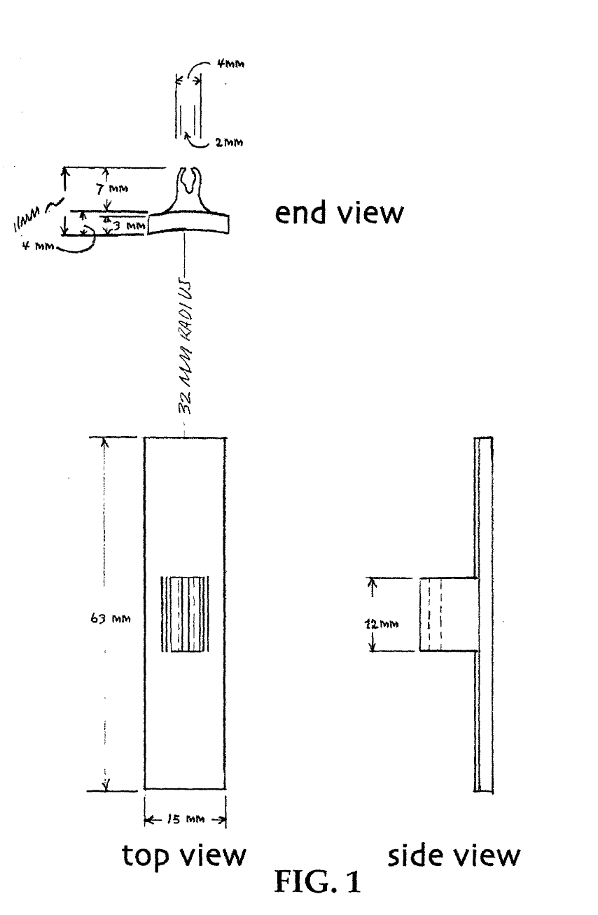

FIG. 2 Oblique view of “Aerosol Spray Tube Holder”.

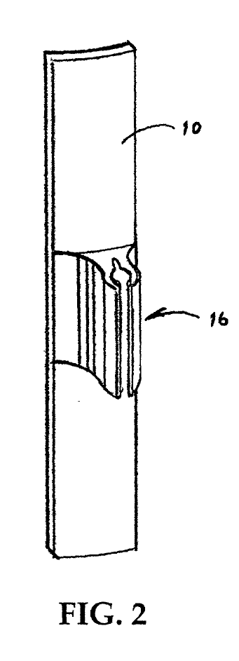

FIG. 3. “Aerosol Spray Tube Holder” in place on can.

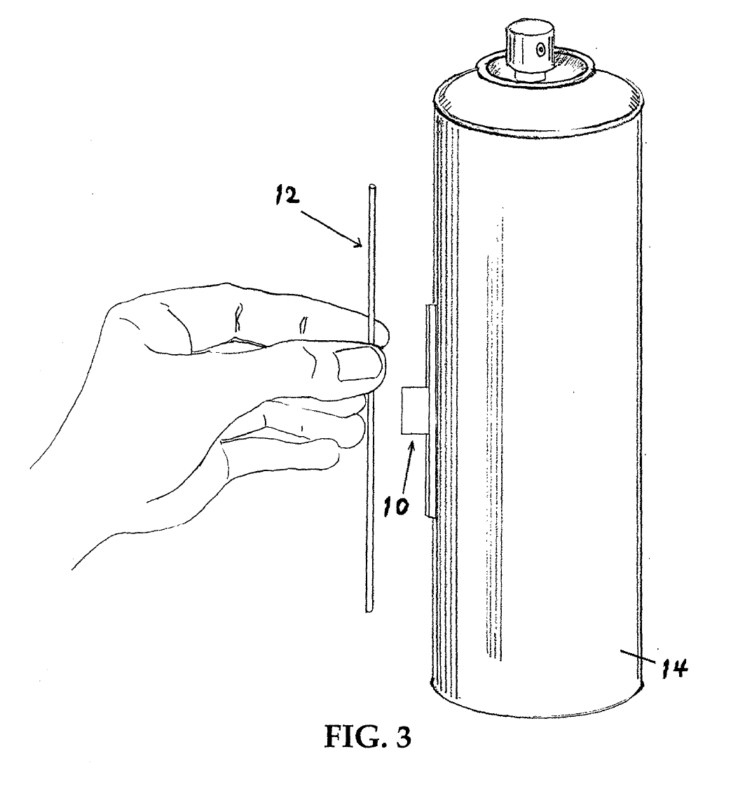

FIG. 4. Tube in place at spray nozzle holder shown in oblique view affixed to can.

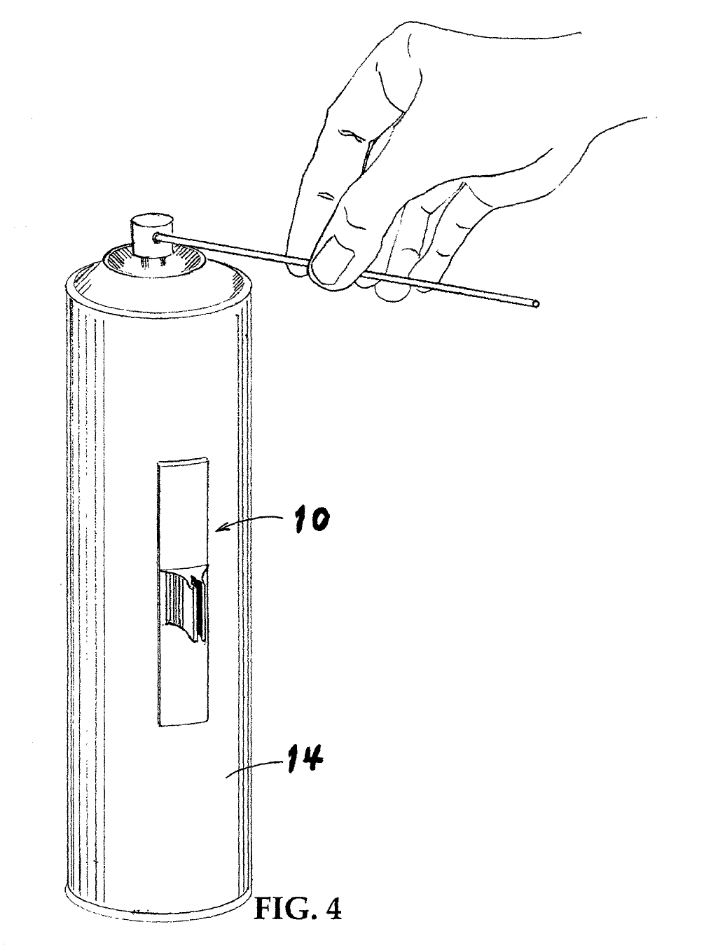

FIG. 5 Top and side view of double sided adhesive used to affix the “Aerosol Spray Tube Holder” to the can.

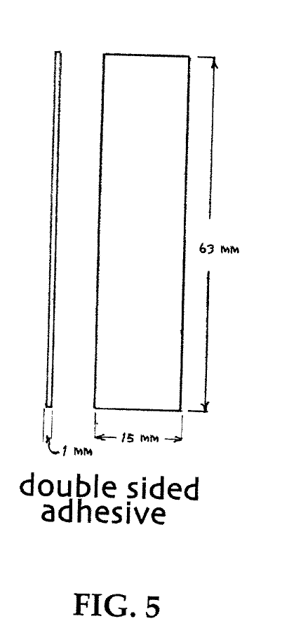

FIG. 6 (2) Views of the “Aerosol Spray Tube Holder” affixed to the can with tube in place.

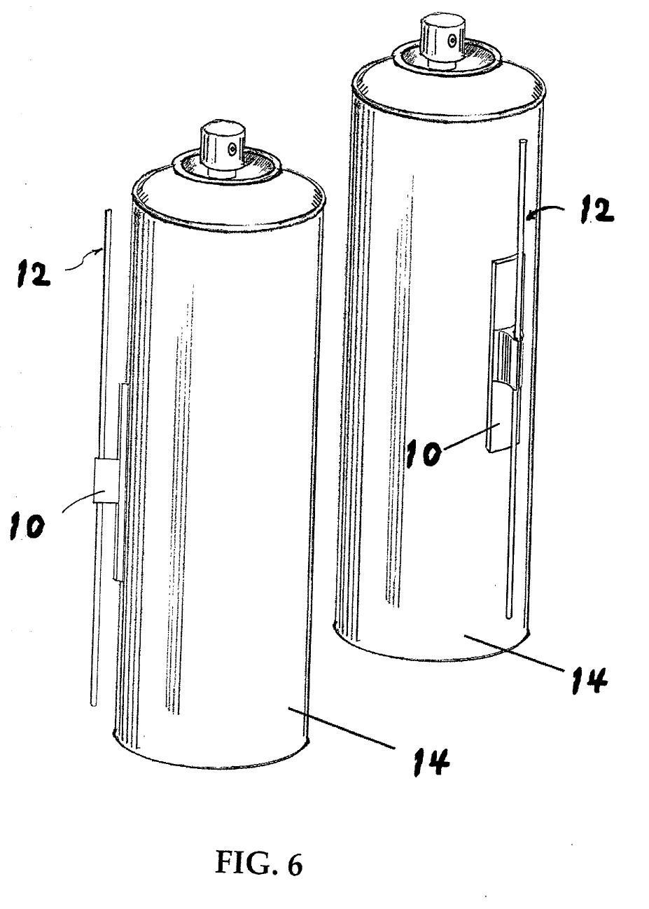

This invention (drawings pages 1 & 2) is designed to mount the spray tube (#12 page 3) used with a typical aerosol can (#14 page 3) in a convenient easy-to-use holder (#10 page 3) directly affixed to the can. This device easily attaches to the can surface (#14 page 4) using the provided double sided tape (page 5), once there, it firmly holds the spray nozzle tube until required for use. When the spray tube is needed it is easily removed from spray tube holder by grasping the spray tube (#12 page 3) and sliding it upward out of the spray tube holder's retainer arms (#16 page 2) and inserting (page 4) the spray tube into the nozzle. The spray tube can be returned to the spray tube holder when needed by snapping the spray tube into the spray tube holder arms with a gentle push on the spray tube using the thumb.

The “AEROSOL SPRAY TUBE HOLDER” is designed to be constructed of High Izod ABS Plastic or High Impact Polystyrene Plastic. The product will be marketed with the double sided tape (page 3) affixed to the base of the “AEROSOL SPRAY TUBE HOLDER”.

I claim:

1. A plastic holder designed and manufactured to hold a directional spray tube.

2. A plastic holder designed to affix conveniently to the side of an aerosol spray can.
